(19) United States
(12) Patent Application Publication
(10) Pub. No.: US 2016/0314424 A1
(43) Pub. Date: Oct. 27, 2016

(54) MOBILE ANALYTICS COLLABORATION ALERTS

(71) Applicant: Wal-Mart Stores, Inc., Bentonville, AR (US)

(72) Inventors: Donald High, Noel, MO (US); Henry Sampara, Bentonville, AR (US); Michael Dean Atchley, Springdale, AR (US)

(21) Appl. No.: 15/136,729

(22) Filed: Apr. 22, 2016

Related U.S. Application Data
(60) Provisional application No. 62/152,349, filed on Apr. 24, 2015.

(51) Int. Cl. G06Q 10/06; H04L 29/08; G06Q 10/10; G08B 21/18

(52) U.S. Cl. CPC G06Q 10/06393; G08B 21/182; H04L 67/26; G06Q 10/103; G06Q 10/1095

(57) ABSTRACT

A system is provided for facilitating responsive mobile analytics collaboration having a communication interface, a memory, and a processor. The system is configured to sample performance data associated with a performance tolerance stored in an electronic alert database, detect an actionable event in response to the sample of the performance data violating a predetermined threshold associated with the performance tolerance, automatically populate a collaborative analytics environment with one or more interactive analytical tools, automatically generate an electronic alert for distribution to a plurality of primary parties associated with the performance tolerance stored in the electronic alert database, and transmit the electronic alert to the plurality of primary parties. The electronic alert prescribes a meeting time based on a desired response time, identifies the actionable event and the violated performance tolerance, and provides electronic access to the collaborative analytics environment.

### CROSS-REFERENCE TO RELATED APPLICATIONS

This application claims priority to and benefit of U.S. Provisional Patent Application No. 62/152,349, filed Apr. 24, 2015, the contents of which are incorporated herein by reference in their entirety.

### FIELD OF INVENTION

The disclosure relates generally to interactive project management systems and more particularly to automated alerts for facilitating responsive collaboration.

### BACKGROUND

Conventionally, electronic alerts are used to advise users of meetings. The alerts conventionally must be manually created by a user and the distribution of invited parties must be manually entered by the user. This configuration can result in delay, added labor, and the potential for error. Furthermore, such systems lack any functionality beyond simply notifying the invitee of a date, time, topic, and meeting location.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram showing an example alert system for facilitating responsive mobile analytics collaboration in accordance with various embodiments.

FIG. 2 is a representation of an example collaborative analytics environment in accordance with various embodiments.

FIG. 3 is a flow diagram illustrating an example method for facilitating responsive mobile analytics collaboration.

FIG. 4 is an example computational device block diagram depicting various components that can be used to implement various of the disclosed embodiments.

FIG. 5 is an example computational device block diagram depicting various components that can be used to implement various of the disclosed embodiments in a distributed system.

### DETAILED DESCRIPTION

As discussed above, conventional electronic alerts serve a limited purpose and require substantial user interaction. Therefore, such systems are generally inefficient and unsuitable for facilitating rapidly responsive collaboration between key interested parties. This disadvantage is especially true where urgent situations arise that require rapid, in-depth data analysis and decisions made on the analysis results.

Methods, systems and computer-readable media are provided herein for facilitating responsive mobile analytics collaboration. The example system, in accordance with various embodiments, includes a communication interface, a memory, and a processing unit configured to execute instructions stored in the memory. Executing the instructions causes the system to sample performance data associated with a performance tolerance stored in an electronic alert database. Executing the instructions also causes the system to compare a sample of the performance data to a predetermined threshold associated with the performance tolerance stored in the electronic alert database. Executing the instructions also causes the system to detect an actionable event in response to the sample of the performance data violating the predetermined threshold. Executing the instructions also causes the system to automatically populate, in response to detection of the actionable event, a collaborative analytics environment with one or more interactive analytical tools, the one or more interactive analytical tools associated with the performance tolerance stored in the electronic alert database. Executing the instructions also causes the system to automatically generate, in response to detection of the actionable event, an electronic alert for distribution to a plurality of primary parties associated with the performance tolerance stored in the electronic alert database, the electronic alert prescribing a meeting time based on a desired response time associated with the performance tolerance stored in the electronic alert database, identifying the actionable event and the violated performance tolerance, and providing electronic access to the collaborative analytics environment. Executing the instructions also causes the system to control the at least one communication interface to transmit the electronic alert to the plurality of primary parties.

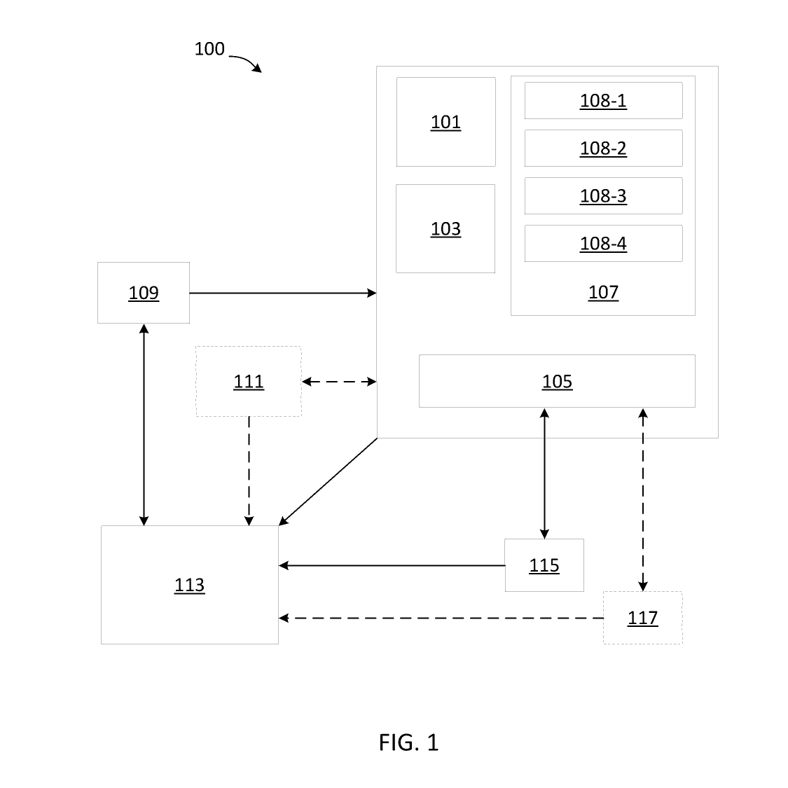

Referring now to FIG. 1, an exemplary responsive collaboration alert system 100 includes a processor 101 for executing instructions stored in a memory 103, an electronic alert database 107 for storing performance tolerances and associated collaborative analytics data, and a communication interface 105 for transmitting electronic alerts. The example system 100 is configured, in accordance with various embodiments, to sample performance data received from a data source 109, compare the sample performance data with a predetermined threshold, detect an actionable event based on a sample of the performance data violating the predetermined threshold, populate a collaborative analytics environment 113 with one or more interactive analytical tools stored in the memory 103 or an analytics database 111, and to transmit, via the communication interface 105, an electronic alert to a plurality of primary parties 115 and/or secondary parties 117.

Processor 101, in accordance with various embodiments can include, for example, but not limited to, a microchip, a processor, a microprocessor, a special purpose processor, an application specific integrated circuit, a microcontroller, a field programmable gate array, or any other suitable processor. Memory 103, in accordance with various embodiments can include, for example, but not limited to, hardware memory, non-transitory tangible media, magnetic storage disks, optical disks, flash drives, computational device memory, random access memory, such as but not limited to DRAM, SRAM, EDO RAM, any other type of memory, or combinations thereof. Communication interface 105, in accordance with various embodiments can include, for example, but not limited to, a built-in network adapter, network interface card, PCMCIA network card, card bus network adapter, wireless network adapter, USB network adapter, modem or any other device suitable for interfacing with any type of network capable of communication and performing the operations described herein.

Electronic alert database 107, includes a plurality of user or system defined performance tolerances 108-i (i=1, 2, 3, 4, . . . , n) and various system-related associations made therewith. In the non-limiting example of FIG. 1, only four performance tolerances (108-1, 108-2, 108-3, and 108-4) are shown. However, other examples can include more or fewer 108-i, In accordance with various embodiments, each performance tolerance 108-i is associated with data received from one or more data sources 109.

The data sources 109 can include, for example, point of sale (POS) locations, inventory management systems, credit or debit card processing devices, surveillance systems, network traffic management systems, storewide monitoring systems, regional data collection centers, national data collection centers, international data collection centers, marketing or public relations monitoring systems, individual computing or mobile devices, data centers, meteorological services, internet service providers, any other data source capable of providing data to the system 100, or combinations thereof. Examples of performance data that can be monitored includes, but is not limited to, gross revenue, gross profit, profit margin, units sold, rate of unit sales, inventory quantity (e.g., in stores, distribution centers, warehouses), rate of usage of inventory, energy consumption, customer volume, supplier volume, any other data, or combinations thereof.

Each performance tolerance 108-i for any given class of performance data can be set based on any suitable measure of performance and is initially created within the electronic alert database 107 based on a system or user input. In accordance with various embodiments, one or more of the performance tolerances 108-i can be manually created by a user within the electronic alert database 107 to correspond to a particular measurement of performance data taken from a particular data source 109. For example, a user can create a performance tolerance 108-i entry in the electronic alert database 107 corresponding to performance data indicating a number of in-stock units of product x in a regional warehouse. The performance tolerance 108-i can then be associated, in the electronic alert database 107, with one or more predetermined thresholds. For example, if a minimum number of units of product x must be in stock for a regional warehouse to adequately supply stores within its service area, a first predetermined threshold can be set for that minimum number of units. Further, if exceeding a maximum number of units of product x indicates an oversupply and/or a need to reduce purchasing of product x, a second predetermined threshold can be set for that maximum number of units. The system 100 would then monitor, via a warehouse inventory data source 109, inventory of product x at the regional warehouse for compliance.

In accordance with various embodiments, one or more of the performance tolerances 108-i can be automatically created by they system 100 within the electronic alert database 107 to correspond to one or more rules or guidelines for a class of performance data. For example, a rule can be set within the system 100 that, nationwide, each regional warehouse must have a minimum unit inventory of product x in stock which is greater than 10% of the average annual number of units of product x sold by all stores within that regional warehouse's service area. The system 100 can then determine average annual unit sales for each regional warehouse's service area by accessing and aggregating sales data sources 109 from each individual store within the relevant service area. Using the determined average annual unit sales for each regional warehouse, the system 100 can then create a plurality of performance tolerances 108-i within the electronic alert database 107, each performance tolerance 108-i associated with a predetermined threshold of a minimum 10% unit inventory. The system 100 would then monitor, via a warehouse inventory data source 109, inventory of product x at each regional warehouse for compliance.

While described above with reference to inventory management, it will be apparent in view of this disclosure that performance tolerances 108-i can be associated with any measure of performance in accordance with various embodiments, including but not limited to, for example, revenue targets, profit targets, security metrics, network usage metrics, employee safety metrics, lost-time metrics, inventory turnover, expenditures, debt ratio, quality metrics, any statistical analyses, any data analytics, any other measure of performance, or combinations thereof. It will be further apparent in view of this disclosure that performance tolerances 108-i can be set at any level of organizational granularity, including but not limited to, for example, individual employees, groups of employees, individual stores or warehouses, individual business units, subsidiaries, regional divisions, national divisions, international divisions, an entire organization, or combinations thereof.

The system 100 then samples the performance data received from the data sources 109 and compares the sampled performance data from each data source 109 with a predetermined threshold of each performance tolerance 108-i associated therewith in the electronic alert database 107. If the sampled performance data violates the predetermined threshold (e.g., exceeds or falls below), in accordance with various embodiments, the system 100 is programmed to detect an actionable event. In accordance with various embodiments, one or more predetermined thresholds are associated with each performance tolerance in the electronic alert database 107. For example, in some embodiments, the performance tolerance 108-i can be associated with a single predetermined threshold, the violation of which results in detection of the actionable event. In accordance with some embodiments, the performance tolerance 108-i can be associated with a plurality of predetermined thresholds. For example, if the performance tolerance 108-i is associated with three predetermined thresholds, violating a first predetermined threshold can indicate a minor violation, resulting in detection of a minor actionable event, violating a second predetermined threshold can indicate a moderate violation, resulting in detection of a moderate actionable event, and violating a third predetermined threshold can indicate a major violation, resulting in detection of a major actionable event.

In accordance with various embodiments, continuing the warehouse inventory example described above, a single predetermined threshold associated with the performance tolerance 108-i can be set, for example at a minimum unit inventory of product x of 10% of average annual sales. Alternatively, in accordance with various embodiments and continuing the warehouse inventory example described above, the performance tolerance 108-i can be associated with a plurality of predetermined thresholds, wherein, for example, a mild violation occurs when unit inventory of product x is lower than 15% of annual sales, a moderate violation occurs when unit inventory of product x is lower than 10% of annual sales, and a major violation occurs when unit inventory of product x is lower than 5% of annual sales. In this way, the system 100, as described with greater detail below, can differentiate between required urgency level and the necessary level of management involvement (e.g., an immediate response and CEO involvement may not be necessary for violation of a predetermined threshold associated with a minor, early-warning type of actionable event but may be necessary for violation of a predetermined threshold associated with a major, crisis type of actionable event).The system 100, upon detection of the actionable event, is configured to automatically populate a collaborative analytics environment 113 with one or more interactive analytical tools associated with the violated performance tolerance 108-i in the electronic alert database 107. Each of the interactive analytical tools can, in accordance with various embodiments, be stored within the memory 103, the electronic alert database 107, or the analytics database 111.

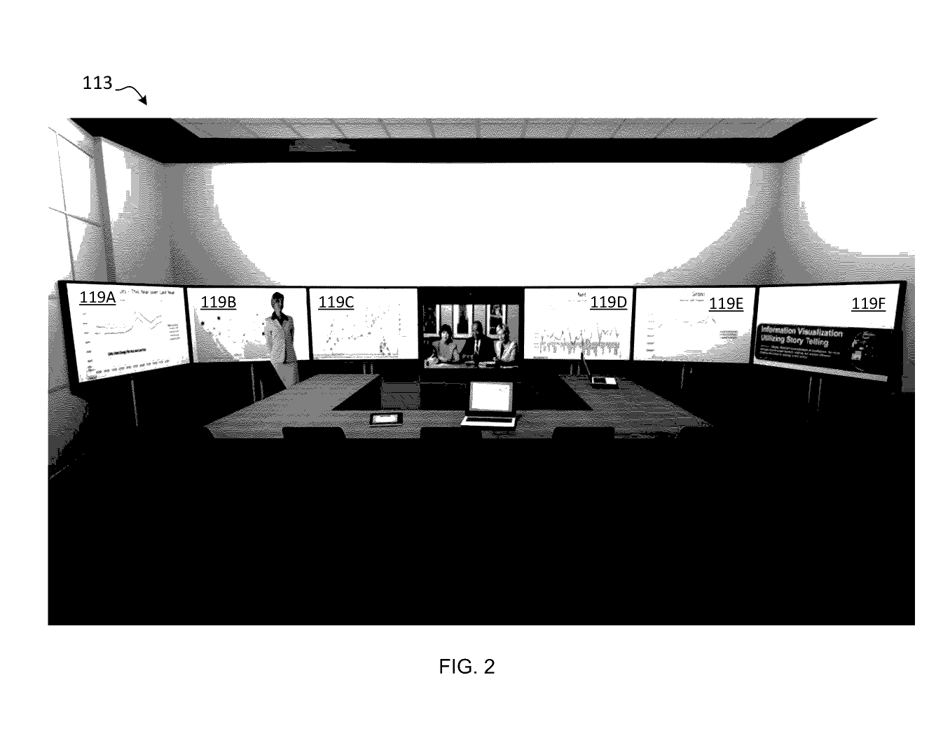

As shown in FIGS. 1 and 2, the collaborative analytics environment 113 can include, in accordance with various embodiments, a plurality of interactive displays 119A-F, each interactive display 119A-F configured to display an output generated by one of the analytical tools. As shown in FIG. 2, the outputs of the analytical tools are not limited to a particular form and can include, for example, charts, graphs, maps, pictures, videos, any other suitable displayed representation of the outputs of the analytical tools, or combinations thereof. In accordance with various embodiments, the collaborative analytics environment 113 can also include a videoconference display (not shown).

In accordance with various embodiments, the collaborative analytics environment 113 can include a digitally created room, wherein displays 119A-F are separate interactive digital renderings of a display and provided within the digital room. In accordance with other embodiments, the collaborative analytics environment 113 can include one or more physical rooms having a plurality of displays 119A-F. Where the collaborative analytics environment 113 includes a physical room, each of the plurality of interactive displays 119A-F can be any suitable display device such as an LED monitor, a CRT monitor, a television, a CRT monitor, a touchscreen, a mobile device display, any other suitable device, or combinations thereof. By using interactive displays 119A-F, a user can further query the displayed results and/or further constrain inputs used during data analysis. For example, if the user wanted to focus on a particular aspect of the data such as, without limitation, only portions of data relating to a geographical region or location, only portions relating to sales of a particular product, or only portions relating to supply chain metrics, etc., the user would input those restrictions to the interactive display 119A-F, thereby filtering the data accordingly.

The system 100, upon detection of the actionable event, is also configured to automatically generate an electronic alert for distribution via the communication interface 105. In accordance with various embodiments, the electronic alert includes meeting time information, wherein the meeting time information is determined by a desired response time associated with the performance tolerance 108-i in the electronic alert database 107. For example, in accordance with various embodiments, an electronic alert sent with regard to a major violation of a business- critical performance tolerance 108-i can be programmed to indicate that a meeting is extremely high priority and will commence immediately whereas an electronic alert sent with regard to a minor violation of a non-critical performance tolerance 108-i can indicate normal priority and provide options for meeting times up to a predetermined number of hours after detection of the actionable event.

The electronic alert can also include a notification of one or more physical and/or digital rooms where the primary 115 and secondary 117 parties can attend the meeting. The electronic alert, in accordance with various embodiments can be, for example, one or more of a text message, a social media message, a pop-up electronic alert, a mobile notification, an email, a voice call, or a video call. For example, the electronic alert can, in accordance with various embodiments, provide a name and location of a physical collaborative analytics environment 113 room and a hyperlink or other means of electronic access to a digital collaborative analytics environment 113 representing the physical location. Alternatively, the electronic alert can provide a hyperlink or other means of electronic access to a digital collaborative analytics environment 113 via, for example, a desktop, laptop, or mobile device and provide notice of one or more physical rooms having the multi-display capability to access and use the digital collaborative analytics environment 113 for users who wish to meet face-to-face.

The electronic alert, in accordance with various embodiments, can be configured to be distributed, via the communication interface, to a plurality of primary 115 and, if applicable, secondary 117 parties prescribed in a distribution list associated with the performance tolerance 108-i in the electronic alert database 107. The plurality of primary parties 115 are generally included as parties with an interest or stake in business areas affected by the data associated with the performance tolerance 108-i, parties possessing the necessary expertise to address relevant actionable events, or any other designated primary party 117. In accordance with various embodiments, secondary parties 117 can be designated alternates or delegates for one or more primary parties, can be parties with expertise that may only require them on an as-needed basis, or can be any other designated secondary party 117.

Some of the primary parties 115 and/or secondary parties 117, in accordance with various embodiments, can be added during initial set up of the relevant performance tolerance 108-i within the system 100. The initial parties 115, 117 can, in accordance with various embodiments, be manually associated with the performance tolerance 108-i in the electronic alert database 107 by a user. The initial parties 115, 117 can, in accordance with various embodiments, be automatically set up by the system 100. For example, in such embodiments, the system 100 can, upon creation of the performance tolerance 108-i in the electronic alert database 107, consult a company directory to identify parties 115, 117 having a stake in the relevant data. In accordance with various embodiments, in continuation of the regional warehouse inventory example discussed above, the system 100 can search a company directory to identify a purchasing manager for the regional warehouse associated with the performance tolerance 108-i and set that purchasing manager as a primary party 115 and, for example, the overall site manager for the regional warehouse as a secondary party 117 in the event that the primary party 115 is unavailable.

The system 100, in accordance with various embodiments, upon setup can be configured to transmit a request for each initial party's 115, 117 electronic alert preferences. Electronic alert preferences can include, for example, a mode of delivery of the electronic alert (e.g., via a text message, a social media message, a pop-up electronic alert, a mobile notification, an email, a voice call, or a video call) and/or designation of one or more additional primary parties 115 or one or more secondary parties 117 (e.g., as an alternate for the primary party 117 or an as-needed expert).

In accordance with various embodiments, the electronic alert is initially distributed only to the primary parties 115. The system 100 can then distribute the electronic alert to selected secondary parties 117 on an as-needed basis. For example, if the system receives an out of office message from a primary party 115 or does not receive a response from a primary party 115 within a prescribed waiting period, a secondary party 117 alternate can then be invited. For further example, if the meeting commences, the system 100 can distribute the electronic alert to one or more secondary parties 117 upon detecting a need for that individual or upon a user request for that individual to attend the meeting in the collaborative analytics environment 113.

In accordance with various embodiments, the system 100 determines a security access level of each primary party 115 and secondary party 117 associated with the distribution and compares each party's 115, 117 access level with a required access level for accessing the data and data analysis models associated with the performance tolerance 108-i for population in the collaborative analytics environment 113. For primary and secondary parties 115, 117 having an insufficient access level, the system 100 can be configured to notify the deficient party 115, 117, notify a designated point of contact, or to automatically submit a request for authorization to increase an access level of the deficient party 115, 117. In accordance with various embodiments, the system 100 can be configured to automatically request pre-authorization to automatically initiate a temporary increase in security access level for the deficient party 115, 117 upon detection of an actionable event. In accordance with various embodiments, the temporary increase in security access level can be instituted for a prescribed period of time, instituted only while the collaborative analytics environment 113 remains populated, or instituted until a user provides instructions to terminate the temporary increase.

In accordance with various embodiments, one or more of the primary parties 115, secondary parties 117, or any other authorized user can manually instruct the system 100 to invite or uninvite additional parties 115, 117. In accordance with various embodiments, the system 100 can be configured to cancel the electronic alert and/or depopulate the collaborative analytics environment 113 in response to one or more additional samples of the performance data from the one or more data sources 109 being within or compliant with the predetermined threshold. In accordance with various embodiments, the system 100 can be configured to invite and/or uninvite various parties 115, 117 in response to one or more additional samples of the performance data form the one or more data sources 109 being in violation of a more severe one of a plurality of predetermined thresholds. For example, in the event a mild violation escalates to a major violation, the system 100 can be configured to switch from a first distribution of primary and secondary parties 115, 117 associated with a minor violation to a second distribution of primary and secondary parties 115, 117 associated with the major violation. In accordance with various embodiments this escalation can result in the addition of parties 115, 117 having a higher, more powerful position within the business in order to facilitate more rapid decision-making or implementation of responses requiring larger mobilizations of resources. In accordance with various embodiments, escalation can result in the use of data models requiring higher security access levels, necessitating the removal and/or addition of various parties 115, 117.

The system 100 can also be configured, in accordance with various embodiments, to produce audio or video recordings of one or more parties 115, 117, one or more of the interactive displays 119A-F, and/or one or more physical rooms. The system 100 can also be configured to log electronic communication associated with the meeting (e.g., via a built-in instant messaging program for participants) or participant attendance. The system 100 can also be configured to log which interactive analytical tools were used, when, and on which display 119A-F. The system 100 can further be configured to log, which filters were applied to each interactive analytical tool.

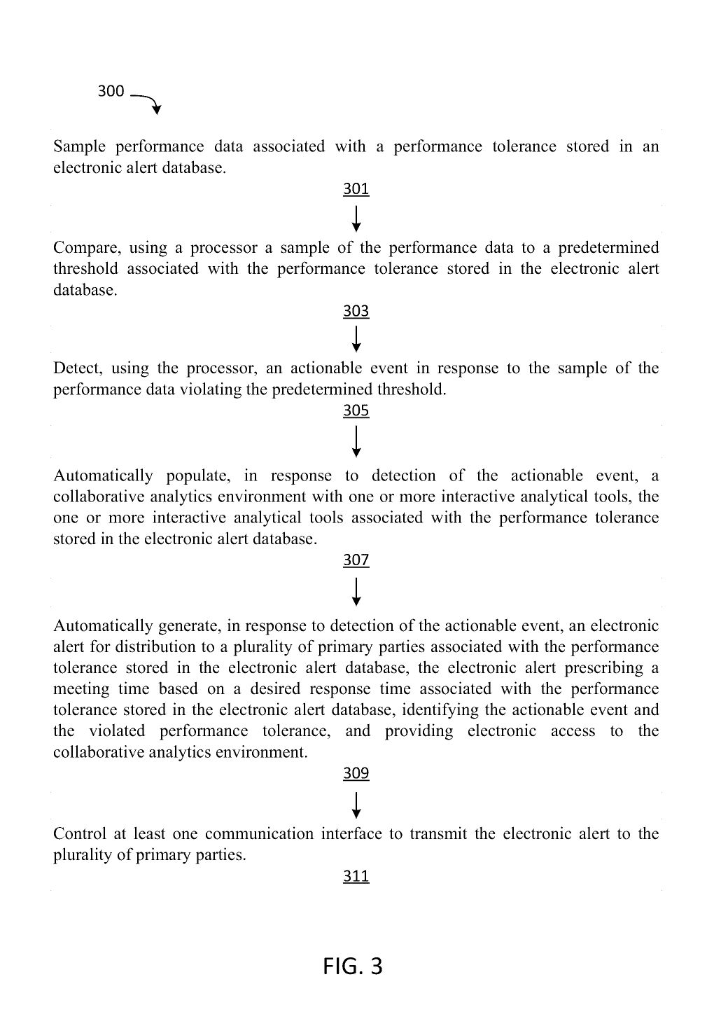

Referring now to FIG. 3, a method is provided for facilitating responsive mobile analytics collaboration. The method includes the step of sampling performance data associated with a performance tolerance stored in an electronic alert database 301. The method also includes the step of comparing, by a processor a sample of the performance data to a predetermined threshold associated with the performance tolerance stored in the electronic alert database 303. The method also includes the step of detecting, by the processor, an actionable event in response to the sample of the performance data violating the predetermined threshold 305. The method also includes the step of automatically populating, in response to detection of the actionable event, a collaborative analytics environment with one or more interactive analytical tools, the one or more interactive analytical tools associated with the performance tolerance stored in the electronic alert database 307. The method also includes the step of automatically generating, in response to detection of the actionable event, an electronic alert for distribution to a plurality of primary parties associated with the performance tolerance stored in the electronic alert database, the electronic alert prescribing a meeting time based on a desired response time associated with the performance tolerance stored in the electronic alert database, identifying the actionable event and the violated performance tolerance, and providing electronic access to the collaborative analytics environment 309. The method also includes the step of controlling at least one communication interface to transmit the electronic alert to the plurality of primary parties 311.

The step of sampling performance data associated with a performance tolerance stored in an electronic alert database 301 can be performed, for example but not limited to, using the communication interface 105 to receive data from one or more data sources 109 and using the processor 101 and memory 103 to record samples of the performance data and as described above with reference to FIGS. 1-2.

The step of comparing, by a processor a sample of the performance data to a predetermined threshold associated with the performance tolerance stored in the electronic alert database 303 can be performed, for example but not limited to, using the processor 101 to compare each sample of the performance data with a predetermined threshold of each performance tolerance 108-i associated with the sampled performance data in the electronic alert database 107 as described above with reference to FIGS. 1-2.

The step of detecting, by the processor, an actionable event in response to the sample of the performance data violating the predetermined threshold 305 can be performed, for example but not limited to, using the processor 101 to identify a sample of the performance data that violates the predetermined threshold of the performance tolerance 108-i as described above with reference to FIGS. 1-2.

The step of automatically populating, in response to detection of the actionable event, a collaborative analytics environment with one or more interactive analytical tools, the one or more interactive analytical tools associated with the performance tolerance stored in the electronic alert database 307 can be performed, for example but not limited to, by populating the collaborative analytics environment 113 with one or more interactive analytical tools from the memory 103 or the analytics database as described above with reference to FIGS. 1-2.

The step of automatically generating, in response to detection of the actionable event, an electronic alert for distribution to a plurality of primary parties associated with the performance tolerance stored in the electronic alert database, the electronic alert prescribing a meeting time based on a desired response time associated with the performance tolerance stored in the electronic alert database, identifying the actionable event and the violated performance tolerance, and providing electronic access to the collaborative analytics environment 309 can be performed, for example but not limited to, by generating an electronic alert according to various timing, security, and distribution information associated with the performance tolerance 108-i in the electronic alert database 107 as described above with reference to FIGS. 1-2.

The step of controlling at least one communication interface to transmit the electronic alert to the plurality of primary parties 311 can be performed, for example but not limited to, by transmitting, via the communication interface 105, the electronic alert to a plurality of primary parties 115 and/or secondary parties 117 as described above with reference to FIGS. 1-2.

### Non-Limiting Example Computing Devices

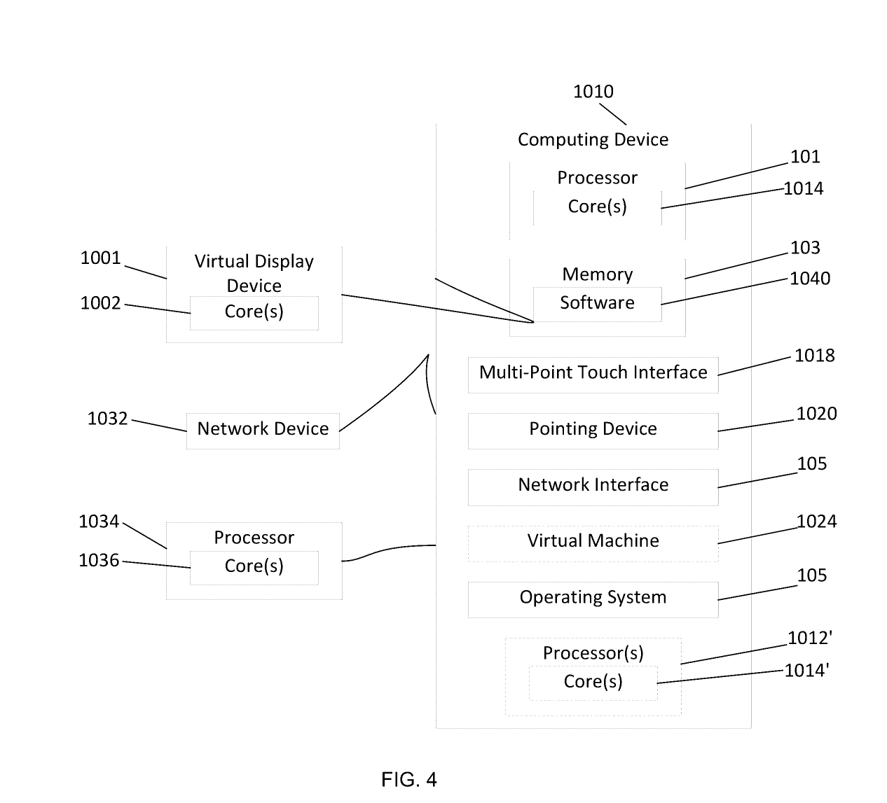

FIG. 4 is a block diagram of an exemplary computing device 1010 such as can be used, or portions thereof, in accordance with various embodiments as described above with reference to FIGS. 1-3. The computing device 1010 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more flash drives), and the like. For example, memory 103 included in the computing device 1010 can store computer-readable and computer-executable instructions or software for performing the operations disclosed herein. For example, the memory can store software application 1040 which is programmed to perform various of the disclosed operations as discussed with respect to FIGS. 1-3. The computing device 1010 can also include configurable and/or programmable processor 101 and associated core 1014, and optionally, one or more additional configurable and/or programmable processing devices, e.g., processor(s) 1012′ and associated core(s) 1014′ (for example, in the case of computational devices having multiple processors/cores), for executing computer-readable and computer-executable instructions or software stored in the memory 103 and other programs for controlling system hardware. Processor 101 and processor(s) 1012′ can each be a single core processor or multiple core (1014 and 1014′) processor.

Virtualization can be employed in the computing device 1010 so that infrastructure and resources in the computing device can be shared dynamically. A virtual machine 1024 can be provided to handle a process running on multiple processors so that the process appears to be using only one computing resource rather than multiple computing resources. Multiple virtual machines can also be used with one processor.

Memory 103 can include a computational device memory or random access memory, such as but not limited to DRAM, SRAM, EDO RAM, and the like. Memory 103 can include other types of memory as well, or combinations thereof.

A user can interact with the computing device 1010 through a visual display device 1001, 111A-D, such as a computer monitor, which can display one or more user interfaces 1002 that can be provided in accordance with exemplary embodiments. The computing device 1010 can include other I/O devices for receiving input from a user, for example, a keyboard or any suitable multi-point touch interface 1018, a pointing device 1020 (e.g., a mouse). The keyboard 1018 and the pointing device 1020 can be coupled to the visual display device 101, 111A-D. The computing device 1010 can include other suitable conventional I/O peripherals.

The computing device 1010 can also include one or more storage devices 1034, such as but not limited to a hard-drive, CD-ROM, or other computer readable media, for storing data and computer-readable instructions and/or software that perform operations disclosed herein. Exemplary storage device 1034 can also store one or more databases for storing any suitable information required to implement exemplary embodiments. The databases can be updated manually or automatically at any suitable time to add, delete, and/or update one or more items in the databases.

The computing device 1010 can include a network interface 1022 configured to interface via one or more network devices 1032 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 1022 can include a built-in network adapter, network interface card, PCMCIA network card, card bus network adapter, wireless network adapter, USB network adapter, modem or any other device suitable for interfacing the computing device 1010 to any type of network capable of communication and performing the operations described herein. Moreover, the computing device 1010 can be any computational device, such as a workstation, desktop computer, server, laptop, handheld computer, tablet computer, or other form of computing or telecommunications device that is capable of communication and that has sufficient processor power and memory capacity to perform the operations described herein.

The computing device 1010 can run any operating system 1026, such as any of the versions of the Microsoft® Windows® operating systems (Microsoft, Redmond, Wash.), the different releases of the Unix and Linux operating systems, any version of the MAC OS® (Apple, Inc., Cupertino, Calif.) operating system for Macintosh computers, any embedded operating system, any real-time operating system, any open source operating system, any proprietary operating system, or any other operating system capable of running on the computing device and performing the operations described herein. In exemplary embodiments, the operating system 1026 can be run in native mode or emulated mode. In an exemplary embodiment, the operating system 1026 can be run on one or more cloud machine instances.

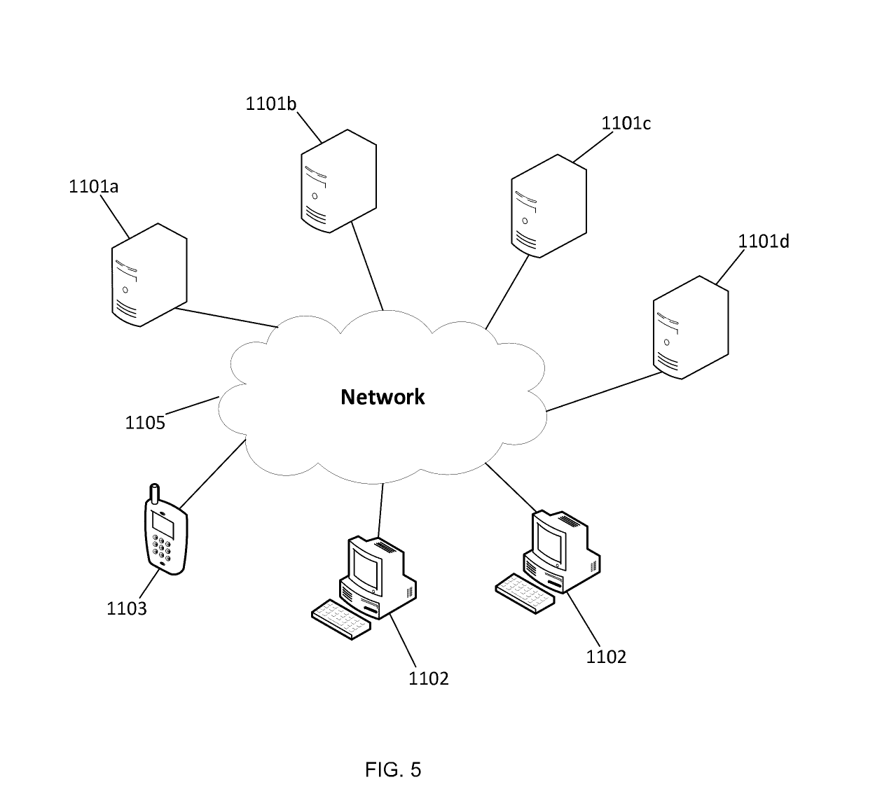

FIG. 5 is an example computational device block diagram of certain distributed embodiments. Although FIGS. 1 and 4, and portions of the exemplary discussion above, make reference to a centralized alert system 100 operating on a single computing device, one will recognize that various of the modules within the alert system 100 may instead be distributed across a network 1105 in separate server systems 1101a-d and possibly in user systems, such as kiosk, desktop computer device 1102, or mobile computer device 1103. For example, users may download an application to their desktop computer device or mobile computer device, which is configured to show an interactive digital rendering of the meeting room and perform the operations of the display device 101, graphical user interface 102, output modules 109A-D, and/or output displays 111A-D. In some distributed systems, the modules of the alert system 100 can be separately located on server systems 1101a-d and can be in communication with one another across the network 1105.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A system for facilitating responsive mobile analytics collaboration, the system comprising:
at least one communication interface;
at least one memory; and
at least one processing unit configured to execute instructions stored in the memory, causing the system to:
sample performance data associated with a performance tolerance stored in an electronic alert database;
compare a sample of the performance data to a predetermined threshold associated with the performance tolerance stored in the electronic alert database;
detect an actionable event in response to the sample of the performance data violating the predetermined threshold;
automatically populate, in response to detection of the actionable event, a collaborative analytics environment with one or more interactive analytical tools, the one or more interactive analytical tools associated with the performance tolerance stored in the electronic alert database;
automatically generate, in response to detection of the actionable event, an electronic alert for distribution to a plurality of primary parties associated with the performance tolerance stored in the electronic alert database, the electronic alert prescribing a meeting time based on a desired response time associated with the performance tolerance stored in the electronic alert database, identifying the actionable event and the violated performance tolerance, and providing electronic access to the collaborative analytics environment; and
control the at least one communication interface to transmit the electronic alert to the plurality of primary parties.

2. (canceled)

3. The system of claim 1, wherein execution of the instructions by the processing unit further causes the system to:
detect at least one of a failure of a primary party to respond to the electronic alert or a failure of a primary party to access the collaborative analytics environment after a prescribed reaction time; and
control the at least one communication interface to transmit the electronic alert to a secondary party designated as an alternate for the primary party; and
automatically initiate a temporary increase in an access level of the secondary party in response to detection of the actionable event.

4. (canceled)

5. The system of claim 1, wherein execution of the instructions by the processing unit further causes the system to associate the plurality of primary parties, the interactive data analysis models, and the desired response time with the performance tolerance stored in the electronic alert database prior to sampling; and
request, from each of the plurality of primary parties, electronic alert preferences, wherein the electronic alert preferences include at least one of a mode of electronic alert delivery or designation of a secondary party as an alternate for the primary party.

6. (canceled)

7. The system of claim 5, wherein execution of the instructions by the processing unit further causes the system to:
receive the electronic alert preferences from the plurality of primary parties; and
associate the received electronic alert preferences with the performance tolerance stored in the electronic alert database.

8. The system of claim 5, wherein execution of the instructions by the processing unit further causes the system to:
compare an access level associated with each of the primary and secondary parties to a required access level associated with each of the interactive data analysis models;
identify a deficient party having a lower access level than the required access level;
control the at least one communication interface to request authorization to automatically initiate a temporary increase in the access level of the deficient party in response to detection of the actionable event: and
receive authorization to automatically initiate the temporary increase in the access level of the deficient party in response to detection of the actionable event; and
associate the authorized temporary increase in the access level of the deficient party with the performance tolerance stored in the electronic alert database.

9. (canceled)

10. (canceled)

11. The system of claim 1, wherein controlling the at least one communication interface to transmit the electronic alert to the plurality of primary parties includes transmitting one or more of a text message, a social media message, a pop-up electronic alert, a mobile notification, an email, a voice call, or a video call.

12. (canceled)

13. (canceled)

14. The system of claim 1, wherein the collaborative analytics environment includes a plurality of interactive displays, each of the one or more interactive analytical tools displayed on a dedicated one of the interactive displays.

15. The system of claim 14, wherein the collaborative analytics environment further comprises a virtual room having the plurality of interactive displays, the plurality of interactive displays of the collaborative analytics environment being presented to a user within a mobile application, desktop application, or via a web browser.

16. The system of claim 14, wherein the collaborative analytics environment further comprises a physical room having the plurality of interactive displays, the plurality of interactive displays being at least one of a computer monitor, a touch screen monitor, a mobile device screen, a projector screen, a holographic projection, or a television.

17. (canceled)

18. The system of claim 1, wherein the performance tolerance includes a minor threshold and a major threshold, wherein violation of the minor threshold is associated with a first distribution of primary parties and a first prescribed meeting time and wherein violation of the major threshold is associated with a second distribution of primary parties and a second prescribed meeting time.

19. (canceled)

20. (canceled)

21. (canceled)

22. A method for facilitating responsive mobile analytics collaboration, the method comprising:
sampling performance data associated with a performance tolerance stored in an electronic alert database;
comparing, using a processor a sample of the performance data to a predetermined threshold associated with the performance tolerance stored in the electronic alert database;
detecting, using the processor, an actionable event in response to the sample of the performance data violating the predetermined threshold;
automatically populating, in response to detection of the actionable event, a collaborative analytics environment with one or more interactive analytical tools, the one or more interactive analytical tools associated with the performance tolerance stored in the electronic alert database;
automatically generating, in response to detection of the actionable event, an electronic alert for distribution to a plurality of primary parties associated with the performance tolerance stored in the electronic alert database, the electronic alert prescribing a meeting time based on a desired response time associated with the performance tolerance stored in the electronic alert database, identifying the actionable event and the violated performance tolerance, and providing electronic access to the collaborative analytics environment; and
controlling at least one communication interface to transmit the electronic alert to the plurality of primary parties.

23. (canceled)

24. The method of claim 22, further comprising:
detecting at least one of a failure of a primary party to respond to the electronic alert or a failure of a primary party to access the collaborative analytics environment after a prescribed reaction time;
controlling the at least one communication interface to transmit the electronic alert to a secondary party designated as an alternate for the primary party; and
automatically initiating a temporary increase in an access level of the secondary party in response to detection of the actionable event.

25. (canceled)

26. The method of claim 22, further comprising associating the plurality of primary parties, the interactive data analysis models, and the desired response time with the performance tolerance stored in the electronic alert database prior to sampling; and
requesting, from each of the plurality of primary parties, electronic alert preferences, wherein the electronic alert preferences include at least one of a mode of electronic alert delivery or designation of a secondary party as an alternate for the primary party.

27. (canceled)

28. The method of claim 26, further comprising:
receiving the electronic alert preferences from the plurality of primary parties; and
associating the received electronic alert preferences with the performance tolerance stored in the electronic alert database.

29. The method of claim 26, further comprising:
comparing an access level associated with each of the primary and secondary parties to a required access level associated with each of the interactive data analysis models;
identifying a deficient party having a lower access level than the required access level;
controlling the at least one communication interface to request authorization to automatically initiate a temporary increase in the access level of the deficient party in response to detection of the actionable event; and
receiving authorization to automatically initiate the temporary increase in the access level of the deficient party in response to detection of the actionable event; and
associating the authorized temporary increase in the access level of the deficient party with the performance tolerance stored in the electronic alert database.

30. (canceled)

31. (canceled)

32. The method of claim 22, wherein controlling the at least one communication interface to transmit the electronic alert to the plurality of primary parties includes transmitting one or more of a text message, a social media message, a pop-up electronic alert, a mobile notification, an email, a voice call, or a video call.

33. (canceled)

34. (canceled)

35. (canceled)

36. (canceled)

37. (canceled)

38. (canceled)

39. (canceled)

40. (canceled)

41. (canceled)

42. (canceled)

43. A non-transitory computer readable medium comprising instructions that when executed cause a computational device to:
sample performance data associated with a performance tolerance stored in the electronic alert database;
compare a sample of the performance data to a predetermined threshold associated with the performance tolerance stored in the electronic alert database;
detect an actionable event in response to the sample of the performance data violating the predetermined threshold;
automatically populate, in response to detection of the actionable event, a collaborative analytics environment with one or more interactive analytical tools, the one or more interactive analytical tools associated with the performance tolerance stored in the electronic alert database;
automatically generate, in response to detection of the actionable event, an electronic alert for distribution to a plurality of primary parties associated with the performance tolerance stored in the electronic alert database, the electronic alert prescribing a meeting time based on a desired response time associated with the performance tolerance stored in the electronic alert database, identifying the actionable event and the violated performance tolerance, and providing electronic access to the collaborative analytics environment; and
control at least one communication interface to transmit the electronic alert to the plurality of primary parties.

44. (canceled)

45. The non-transitory computer readable medium of claim 43, wherein execution of the instructions further causes the computational device to:
detect at least one of a failure of a primary party to respond to the electronic alert or a failure of a primary party to access the collaborative analytics environment after a prescribed reaction time; and
control the at least one communication interface to transmit the electronic alert to a secondary party designated as an alternate for the primary party.

46. (canceled)

47. (canceled)

48. (canceled)

49. (canceled)

50. (canceled)

51. (canceled)

52. (canceled)

53. The non-transitory computer readable medium of claim 43, wherein controlling the at least one communication interface to transmit the electronic alert to the plurality of primary parties includes transmitting one or more of a text message, a social media message, a pop-up electronic alert, a mobile notification, an email, a voice call, or a video call.

54. (canceled)

55. (canceled)

56. (canceled)

57. (canceled)

58. (canceled)

59. (canceled)

60. The non-transitory computer readable medium of claim 43, wherein the performance tolerance includes a minor threshold and a major threshold, wherein violation of the minor threshold is associated with a first distribution of primary parties and a first prescribed meeting time and wherein violation of the major threshold is associated with a second distribution of primary parties and a second prescribed meeting time.

61. (canceled)

62. (canceled)

63. (canceled)
